(19) United States
(12) Patent Application Publication
(10) Pub. No.: US 2004/0069708 A1
(43) Pub. Date: Apr. 15, 2004

(54) System and method for treating whole blood

(76) Inventors: Thomas Laurell, Lund (SE); Henrik Jönsson, Lund (SE); Mats Allers, Lund (SE); Hans W Persson, Lund (SE)

Correspondence Address: Richard J Streit, Ladas & Parry, Suite 1200, 224 South Michigan Avenue, Chicago, IL, 60604, US

(21) Appl. No.: 10/467,842

(22) PCT Filed: Mar. 11, 2002
(86) PCT No.: PCT/SE02/00427

(30) Foreign Application Priority Data
Mar. 9, 2001 (SE) 0100820-0
Mar. 9, 2001 (SE) 0100819-2
Apr. 9, 2001 (SE) 0101272-3
Sep. 12, 2001 (SE) 0103013-9

(51) Int. Cl. C02F 1/44

(52) U.S. Cl. 210/646

(57) ABSTRACT

The present invention relates to a method and an apparatus for treatment of whole blood comprising two steps, firstly, a step of extracorporeal preseparation whereby the whole blood is separated into a blood plasma rich component and a blood cell rich component and secondly, a step of collecting and/or treating the plasma rich component, e.g. performing dialysis, plasma donation or plasma-pheresis. In one embodiment of the invention, the blood plasma rich component is achieved after particle separation using an ultrasound separator comprising micro-channels formed in a plate structure.

### FIELD OF THE INVENTION

The present invention refers to system and method for use in treatments such as dialysis treatment, plasma donation or plasmapheresis. The invention more specifically refers to such systems comprising means for separating the blood into two or more components before treating one of the components, especially such a system and method comprising particle separation by means of ultrasound.

### BACKGROUND

Treatment of whole blood comprising separation of particles is important within several fields of medical technology and different separation methods are used for example in connection with blood donations, dialysis treatment, plasma donation, plasmapheresis, and in laboratory analysis, in the development and manufacture of pharmaceuticals.

Thus, an important field for particle separation is the separation of blood plasma from blood cells, whereby the separated blood plasma can be used in for example dialysis treatment, i.e. removing e.g. breakdown products from the separated plasma rich component before the blood plasma is united with the separated blood cells and reinjected or reinfused to the patient.

Another important field for particle separation is the separation of blood plasma from blood cells, wherein particles or proteins is further separated from the plasma rich component before it is used as a donor plasma or as a raw product in the production of pharmaceuticals.

Yet another important field is the separation of blood plasma from blood cells for use of the blood plasma in plasmapheresis, wherein the separated plasma rich component is substituted with new blood plasma or another fluid, or is exposed to a process with for example monoclonal antibodies to remove toxines or proteins before the blood plasma is reinjected or reinfused to the patient.

### Prior Art

In prior art there is several examples of systems and methods for treatment of whole blood comprising separation of blood into a cellular component and a plasma component, wherein the plasma component is treated or purified before it may be united with the cellular component and recycled to the patient.

As an example, U.S. Pat. No. 4,702,841 discloses a method for extracorporeal removal of a toxin from blood, wherein the blood plasma is separated from cellular components, treated and united with the cellular components. Further, U.S. Pat. No. 4,702,841 comprises separation of whole blood by means of a centrifuge, a plasma filter or a microfilter.

Another example is U.S. Pat. No. 4,728,430, which discloses a process and an apparatus for separating whole blood into a cellular component and a plasma component by means of a centrifuge. Further, U.S. Pat. No. 4,728,430 discloses separation of the plasma component into two different plasma components having different molecular weights. This separation of the plasma component is performed by means of a microfiltration membrane.

However, the prior art does not disclose a system and a method for treatment of whole blood that comprise a first step of extracorporeal preseparation of whole blood using ultrasound and a second step of collecting and/or treating the blood plasma rich component.

### Object of the Invention

The general object of the present invention is to solve the problem of providing an increased separation of particles in blood, i.e. to separate blood plasma from blood cells with a higher degree of purification, for use in for example plasma donation, dialysis treatment and plasmapheresis.

The invention also aims to solve the following aspects of the problem:

to provide separation of particles and at the same time decreasing or removing the risk of blocking a separation filter due to particle clogging in said filter;

to provide separation of particles and at the same time decreasing or removing the risk of decreasing filter permeability with time due to particle clogging in the separation filter;

to provide an increased process speed;

to provide treatment of whole blood in a highly automated process requiring a minimum of a user's time for managing the equipment,

to provide a system for treatment of whole blood, wherein the separation of particles in the blood is such that the risk for contamination in the processed blood liquid is decreased;

to provide a blood treatment system enabling an automatic blood treatment process; and

to provide a system for treatment of whole blood, comprising particle separation which is more gentle to the blood cells, as compared to existing techniques utilizing for example centrifuigal force. A more gentle separation method reduces the disruption of red blood cell membranes (hemolysis).

### SUMMARY OF THE INVENTION

The stated problem is solved in accordance with the present invention for treatment of whole blood, comprising a first step of preseparating the whole blood and a second step of collecting and/or treating the blood plasma component achieved from the preseparation step. One of the key components of the invention is a particle separation apparatus that generates ultrasound standing waves in a microchannel system formed in a surface portion of a plate.

The method for treatment of whole blood comprises the steps of:

supplying blood to a separation apparatus, by means of a first conduit;

separating blood cells from blood plasma, establishing a blood cell rich component and a blood plasma rich component, by means of the separation apparatus;

transporting the blood cell rich component from the separation apparatus by means of a second conduit;

supplying the blood plasma rich component to a treatment apparatus; by means of a third conduit, and

treating the blood plasma rich component, by means of the treatment apparatus.

An embodiment of the system for treatment of whole blood comprises a separation apparatus, a treatment apparatus, fluid conduits and control means, wherein a first conduit is arranged to transport blood to the separation apparatus. The embodiment is characterized in that the separation apparatus is arranged to separate blood cells from blood plasma using ultrasound. Further, the blood cells are transported from the separation apparatus via a second conduit and the blood plasma is transported to the treatment apparatus via a third conduit, which treatment apparatus is arranged to treat the blood plasma rich component.

The separation apparatus, according to one embodiment of the invention, is arranged to perform particle separation by means of ultrasound. In one embodiment of the invention the separated blood cells and the treated or collected blood plasma component are united in a fourth conduit, whereby the treated or collected blood plasma component and the separated blood cells may be recycled to the living being.

In one embodiment of the invention, the treatment apparatus is a dialysis apparatus arranged to remove breakdown products from the blood plasma, wherein the dialysis apparatus is arranged to be e.g. a dialysis filter. In another embodiment of the invention the treatment apparatus is a membrane for donor plasma and arranged to separate particles or proteins, whereby the treated blood plasma rich component is donated. In yet another embodiment the treatment apparatus is a treatment unit arranged to expose the blood plasma rich component to monoclonal antibodies or to destroy or discard the blood plasma rich component.

Further, the separation step as part of the inventive concept is preferrably performed by, in a separation apparatus, generating standing ultrasound waves in a channel system formed in a surface portion of a plate, such that particles having a certain property are influenced by forces from the standing wave bringing them into certain positions related to the nodes of the standing wave field. The channel system comprises channel units; each unit comprises a channel base stem and a trifurcation that gives rise to one central and two lateral branches. A flow of liquid is generated through said channel units and particles having a certain property is influenced by forces from the standing wave and brought into positions related to the nodes of the standing wave field. The nodes and antinodes are generated in positions so that the position of a node is such that a laminar flow involving that node will travel in a certain branch, i.e. the node is arranged in front of a branch, and a neightboring antinode is arranged in front of another branch. Due to the laminar flow created in the small channels, the lateral lamina are flowing to the lateral branches and the central lamina is flowing to the central branch. Particles in the respective lamina are following the flow into the respective branch.

### Definitions

In the present text the following terminology will be used:

Separated blood refers to the blood cell rich component after particle separation. This liquid contains blood cells and platelets together with some blood plasma and possible unwanted substances. The amount of blood plasma and possible unwanted substances is related to the efficiency of the separation apparatus. In optimal particle separation the liquid includes only blood cells.

Collected blood is blood that has been collected from a living being, and comprises blood cells, platelets, blood plasma and possible unwanted substances such as fat emboli, complementary complexes, deranged coagulation factors, cytostatics and/or products resulting from massive fibrinolysis.

Ultrasound microchannel separator refers to an apparatus comprising small channels in the sub millimeter range, and capable of generating ultrasound standing waves between opposing walls of said channels. Said apparatus being capable of separating a liquid into two or more components by way of bringing components with different composition into different branches of said channels. When the functional unit of an ultrasound microchannel separator is fed with a liquid particles in the liquid are subjected to forces exerting the particles towards the nodes or antinodes of the standing waves. The particles will thereby be arranged at different locations depending on their physical properties. Particles having a certain size, density and/or compressibility are for example held or fixed in the nodes of the standing waves and particles having another size, density and/or compressibility can be carried with a flow of blood or a substitution fluid through the field of the standing waves. The size of the particles that are separated can be varied dependent on the distance between opposing walls of the channel unit or dependent on the ultrasound frequency. Furthermore different particles having the same size can be separated dependent on their acoustic properties or density.

Nodes refer to pressure nodes, where particles of higher density than the medium and/or lower compressibility will tend to accumulate, due to the inherent physical properties of an ultrasound standing wave.

Antinodes refer to pressure antinodes, where particles of lower density than the medium and/or higher compressibility will tend to accumulate, due to the inherent physical properties of an ultrasound standing wave.

Micro-particles refer to particles having a diameter less than 15 micrometer.

### BRIEF DESCRIPTION OF THE DRAWINGS

The present invention for treatment of whole blood will be described below with reference to the accompanying FIGURES in which:

FIG. 1a shows an overview of an ultrasound micro-channel separation unit,

FIG. 1b shows the embodiment of FIG. 1a with more detailed numbering.

FIG. 1c shows the embodiment of FIG. 1a with a detail of a parallel arrangement of eight channel units;

FIG. 2 shows schematically a dialysis apparatus comprising a micro-channel separator;

FIG. 3 illustrates flow profile and particle distribution in capillary;

FIG. 4a shows schematically a serial arrangement of two channel units;

FIG. 4b illustrates a separation of two different kinds of particles with different density;

FIG. 4c illustrates a channel unit with three inlets and three outlets;

FIG. 4d illustrates the channel unit of FIG. 19 including particles;

FIG. 4e shows schematically a radial arrangement of the channel units;

FIG. 4f shows the embodiment of FIG. 21 in perspective;

FIG. 5 shows a top view of a cross channel system arrangement;

FIG. 6 shows a perspective view of the object in FIG. 5;

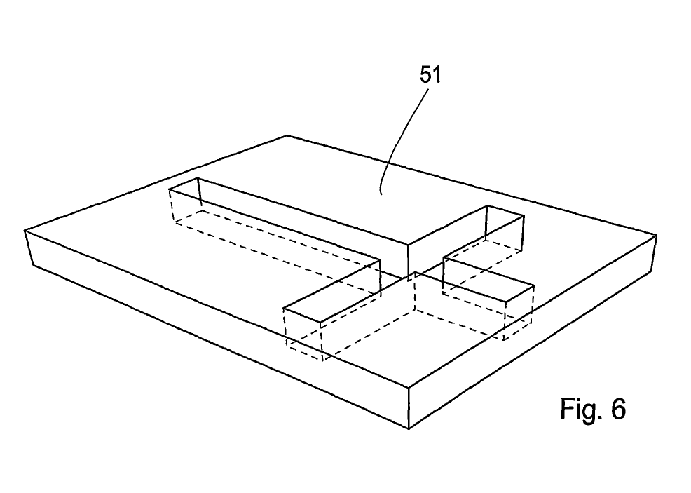

FIG. 7 shows a bottom view of the object in FIG. 5, ultrasound source omitted for clarity;

FIG. 8 shows a side view of the object in FIG. 5;

FIG. 9 shows a top view of a repeated arrangement;

FIG. 10 shows a detail top view of a parallel arrangement branching point, illustrating thin dividing walls;

FIG. 11 shows standing waves in the space between two walls of a channel;

FIG. 12 shows a cross section view of the object of FIG. 5;

FIG. 13 shows schematically separation using a one-node standing wave;

FIG. 14 shows schematically separation using a two-node standing wave;

FIG. 15 shows schematically a one-node three-step fluid exchange;

FIG. 16 shows schematically a one-node three-step concentrator;

FIG. 17 shows schematically a one-node four-step integrated fluid exchanger and concentrator;

FIG. 18 shows a top view of an embodiment with labeled branching angles;

FIG. 19 shows a principal embodiment of a system according to the invention for treatment of whole blood comprising dialysis treatment;

FIG. 20 shows in more detail another embodiment of a system according to the invention for treatment of whole blood comprising dialysis treatment;

FIG. 21 shows in more detail an embodiment of a system according to the invention for treatment of whole blood comprising plasma donation;

FIG. 22 shows in more detail an embodiment of a system according to the invention for treatment of whole blood comprising plasmapheresis;

### DETAILED DESCRIPTION OF PREFERRED EMBODIMENTS

The present invention relates to a method, an apparatus for treatment of whole blood, comprising extracorporeal preseparation, wherein the treatment of whole blood comprises two steps. Firstly, a step of extracorporeal preseparation wherein the, whole blood is separated into a plasma rich component and a component rich of blood cells and secondly, a step of collecting and/or treating the plasma rich component, e.g. performing dialysis treatment, plasma donation or plasmapheresis. In one embodiment the blood plasma is achieved after particle separation using ultrasound. Furthermore, the invention refers to a plasma product and blood product obtained by the system and the method for treatment of blood plasma.

Embodiments of the present invention for treatment of whole blood will now be described with reference to the accompanying FIGS.

Hemodialysis Apparatus Comprising an Ultrasound Microchannel Separator

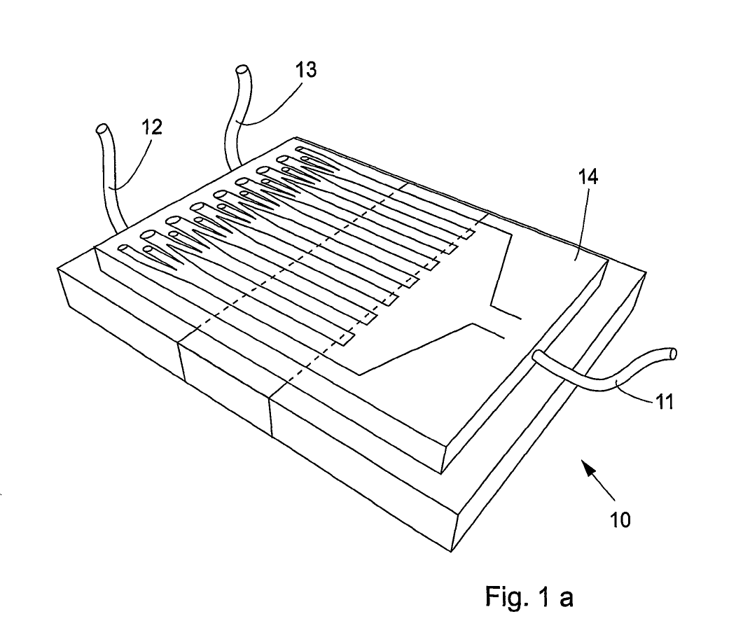

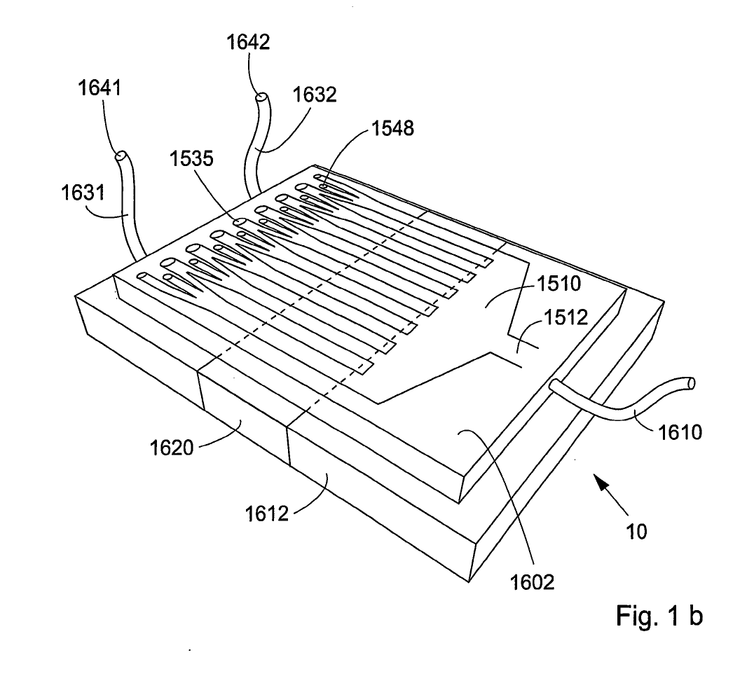

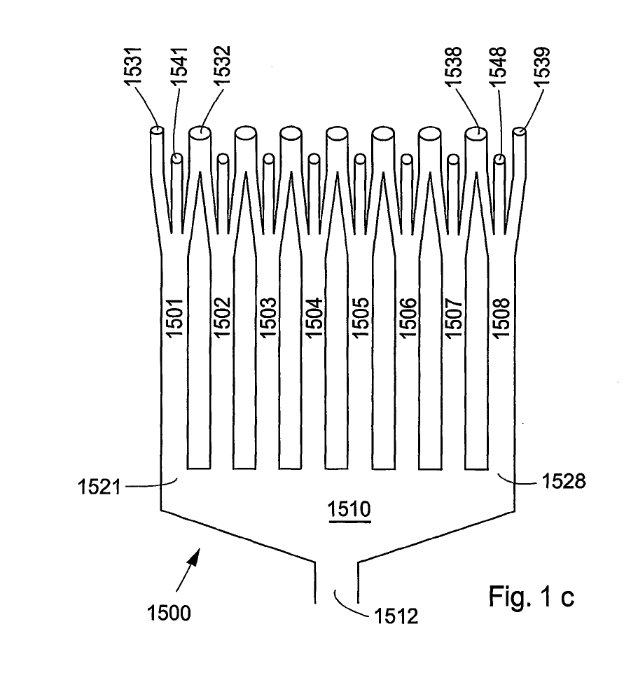

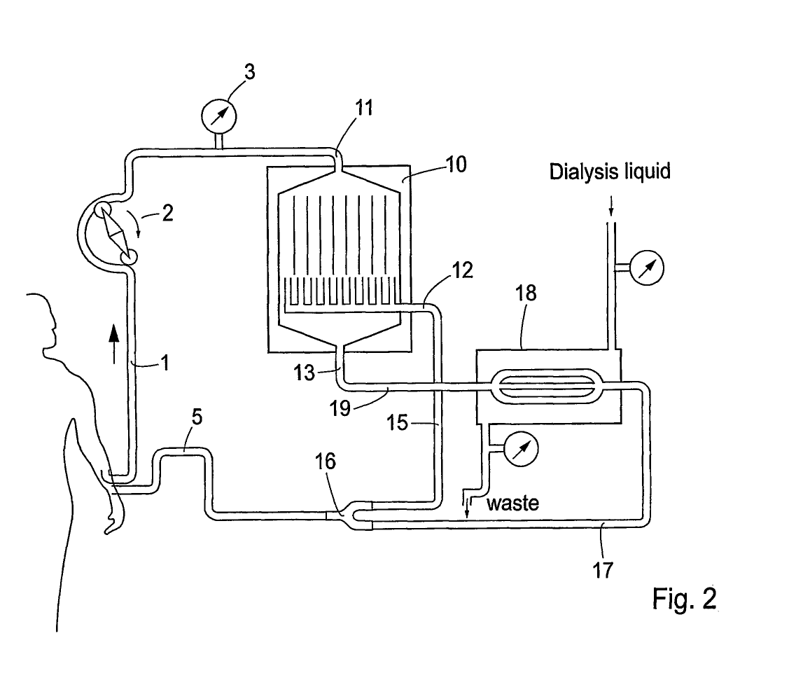

FIGS. 1a, 1b and 1c shows an ultrasound microchannel separator 10 being an embodiment of the inventive concept of the present invention. FIG. 2 shows schematically a hemodialysis apparatus comprising said ultrasound microchannel separator 10. Said dialysis apparatus further comprises an arterial conduit 1 capable of leading the blood from a patient to a pump 2, which provides the required pumping energy to the apparatus. A first pressure is measured with a pressure gauge 3. The blood is brought to the inlet 11 of the ultrasound microchannel separator 10. Said separator is capable of separating the blood into one blood cell rich component meant for a first outlet 12, and a plasma rich component meant for a second outlet 13. The plasma rich component is then dialysed in a dialysis unit 18 and subsequently led to a Y-connector 16 where the dialysed plasma rich component is mixed with the blood cell rich component from the first outlet 12 of the separator 10. The mixed blood then can be returned to the patient via a venous return conduit 5.

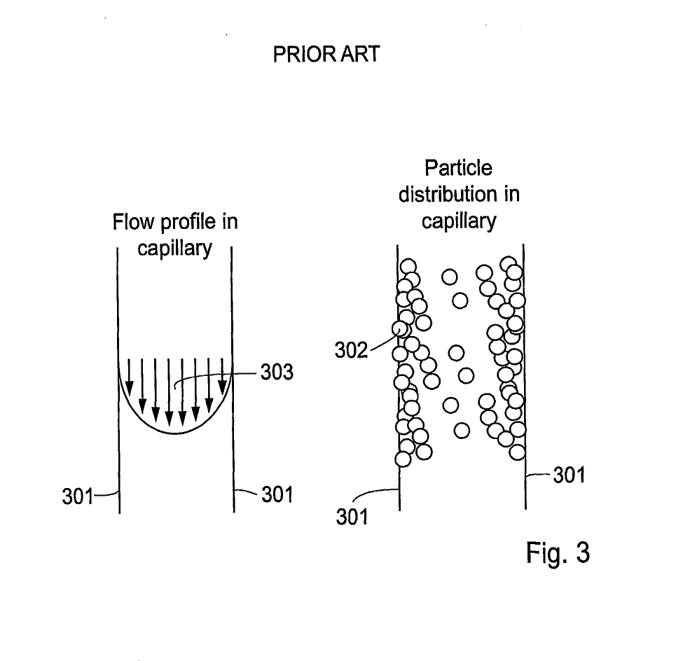

The advantage of only having to perform dialysis on the plasma component can be understood by studying FIG. 3, which FIGURE shows the flow profile and the particle distribution in a capillary conduit of a dialysis apparatus devised to dialyse whole blood, according to prior art. One problem is that the dialysis membrane 301 becomes clogged, because blood corpuscles 302, mainly platelets, get stuck in said membrane. The flow profile 303 including blood corpuscles in spaces of capillary dimensions, like in a dialysis membrane, encompasses two things; first, the flow near the walls i.e. the membrane, is the smallest. This is disadvantagous because most of the plasma flows in the middle, and will not participate in the desired dialysis near the membrane, see FIGURE. By using a separation according to an embodiment of the invention it is possible to dialyse the plasma only, eliminating the undesirable effect from platelets. The dialysis membrane can be replaced with a more effective membrane. It is probably possible to achieve a dialysis having the same or better effect, at a lower flow speed than embodiments of known art. With a preseparation the leukocytes cells will not come in contact with the dialysis membrane, and therefore the risk for leukocyte activation is significantly reduced with a preseparation.

The ultrasound micro-channel separator is realized on a micro-scale, and is an apparatus devised for separating a fluid containing suspended particles into fractions of higher and lower concentration of said suspended particles using ultrasound standing waves and micro-technology channels formed in the surface portion of a plate 14, 51 having integrated branching points or branching forks 120, 130, 140, and an ultrasound source arranged in close contact to an opposing surface of said plate. The concept of the separation system is based on the knowledge that when particles in a fluid are subjected to an acoustic standing wave field, the particles are displaced to locations at, or in relation to the standing wave nodes. More particularly, the present embodiment provides a device for separating particles from fluids using ultrasound, laminar flow, and stationary wave effects comprising a micro-technology channel system in plate 14, 15 with integrated branching points or branching forks, making it possible to use one or more ultrasound sources. One of the characteristics of the separation system is that it is possible to design a device with a single ultrasound source, which generates the standing waves. This is possible because the channel system and branching point are formed in one piece of material or in a few pieces of material closely bonded together.

Standing waves are generated in the channels so that particles suspended in the fluid are brought into certain lamina of said fluid, and that one or more lamina are formed devoid of particles, or are formed carrying particles of different properties than the first mentioned ones. Said laminae are thus arranged perpendicular to said plate, this is important because the branching of a channel must take place within the plate, so that a connection with another channel can take place also within the same plate. The advantages of this will be obvious below.

One of the characteristics of the invention is that the ultrasound source is arranged in perpendicular contact with the plate, conveying ultrasound energy in a direction that is perpendicular the plate. The inventors have tested and proved that in embodiments of the present invention, as a result of the dimensions of the channels and the properties of the plate and the ultrasound transmitter, a standing wave is generated that reaches from one side wall of a channel to the opposing side wall of the same channel. It would normally be expected that such an arrangement would generate (only) a standing wave reaching from a bottom wall to a top wall of said channel, continuing in a direction of the original energy flow.

The inventors have also realised the great importance of this idea. Because, according to the invention, the ultrasound source now do not have to be a part of a plate layer where the channels reside, and because space becomes available for packing more channels into a limited space, greatly enhancing the possibilities of manufacturing devices with a multitude of parallel channels providing high capacity particle separation. As another aspect, a high degree of particle separation could also easily be provided by a serial arrangement of separation units, as will be further explained below. The capability of high yield parallel and serial processing of a fluid using ultrasound is thus a central part and consequence of the inventive concept.

The above is possible because the channels and branching points are formed in a plate comprising one piece of material or in a few pieces of material closely bonded together. No special reflectors or the like are needed. It may also be possible to use more than one ultrasound source. Thin dividers are arranged to separate the laminar flows after the branching points, thereby enhancing the effectiveness of the device. The device is preferably manufactured using silicon technology benefiting from the possibility of small precise dimensions, and the ultrasound energy could preferably be delivered by a piezoelectric element, which in turn could be driven from a control unit capable of delivering electrical energy of certain shape, frequency and power.

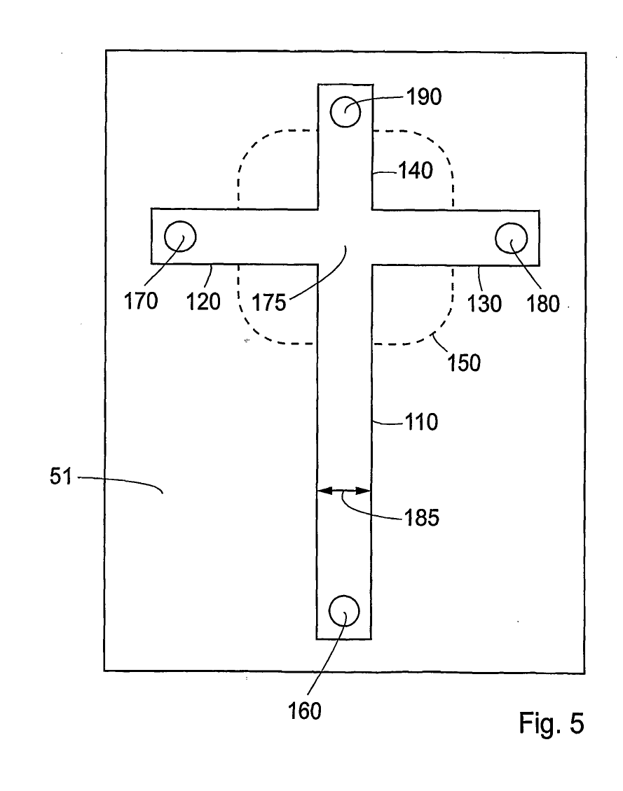

Referring to FIG. 5, 6, and 12, one embodiment of the separation system comprises a plate 51, 851 with a channel unit, having a base stem 110 and a left arm 120, a right arm 130 and a central arm 140. The walls of the base stem 810, 820 are essentially perpendicular to the plate and parallel or near parallel to each other, which is important for the establishment of a standing wave across the entire depth and length of the channel, see below.

At the back of the plate 51, means for delivering ultrasound energy to said plate 51 is arranged in the form of a piezoelectric element 150, 853. The device will finction as follows:

A fluid with suspended particles entering the base stem 110 at the inlet 160 will flow towards the branching point 175 because of an arranged pressure gradient, which gradient could be created by e.g. a pump. By controlling the frequency of the ultrasound and use certain fiequencies suitable to the dimensions of the base stem 110, especially the width 185 of said stem 110, a stationary wave pattern will form in the fluid inside said stem 110. Especially there will form a stationary wave pattern orthogonal to the direction of the flow between the left 810 and right 820 wall of the base stem 110. Nodes will form in greater numbers in the middle part of the channel than at the walls, where antinodes will form. During said flow, particles in the fluid will tend to accumulate in nodes of said stationary wave-pattern, or in certain layers in relation to the nodes depending on the particles' density/densities/acoustic impedance relative to the surrounding fluid. Particles with a higher density than said surrounding fluid will tend to accumulate in the nodes, whereas particles with a density lower than the surrounding fluid will tend to accumulate in the antinodes. The layers of fluid discussed in the following are the layers parallel to the side walls 810, 820 of the base stem 110.

Depending on the density/acoustic impedance, size and weight of the particles, certain patterns of accumulations of particles will be formed. This is an advantage when separating out particles of a certain weight and/or size from a medium containing a spectrum of particles of different density/acoustic impedance. Generally, particles having a density higher than the fluid without particles, accumulates in the nodes, and particles having a density lower than the fluid without particles, accumulate in the antinodes. By providing a branching fork in the shape shown in FIG. 5, 10 or 18, it is possible to separate out said particles. The post-branch arms or charmels could preferably have a spacing adapted to the wavelength, i.e., a centre to centre distance of approximately ⅜ of a wavelength.

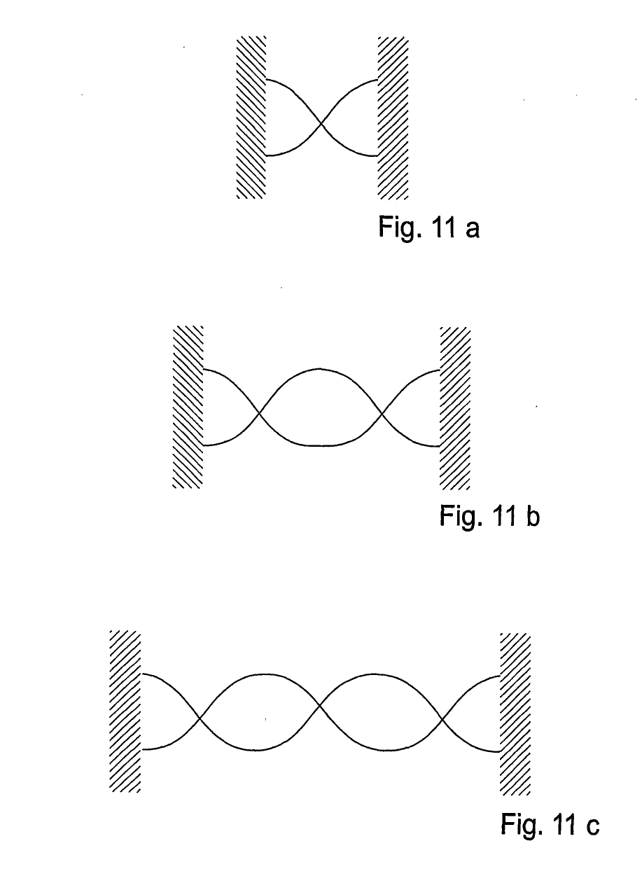

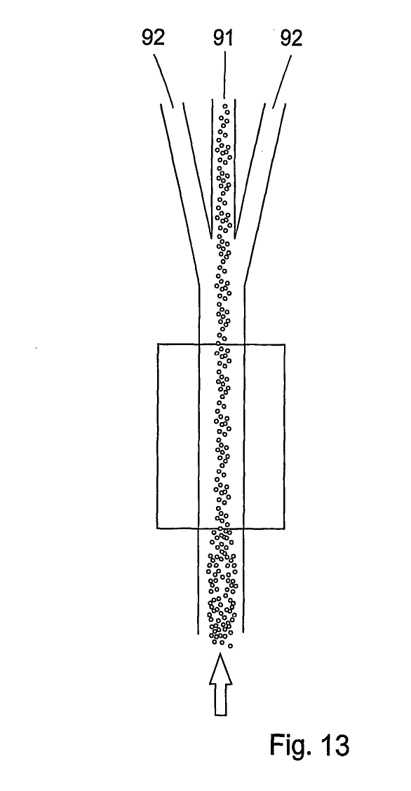

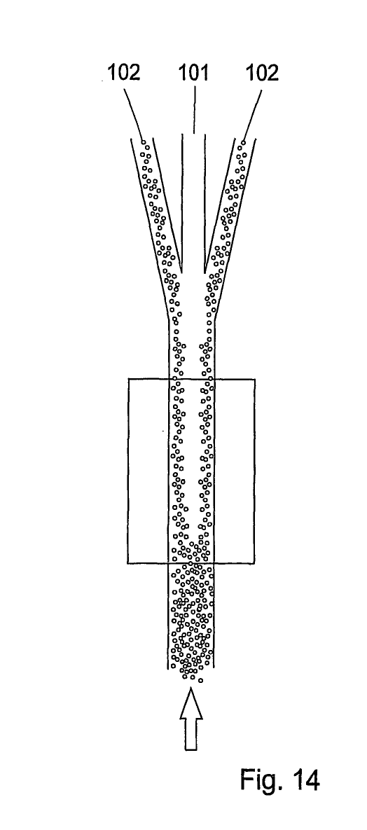

Depending on the resonance conditions, confer FIG. 11, different results of the above will be obtained. For a single node condition 11a, the result of the above is that the layers of fluid near the walls of the base stem 110 will contain a decreasing concentration of high density particles as the fluid flows along said stem 110 towards the branching point 175. At said branching point 175, fluid, that mainly originates from the central parts of the fluid-stream in the stem 110, will, due to laminar flow continue its movement straight ahead and enter the central arm 140. Fluid originating from the fluid-stream appearing near the walls of the stem 110, will deflect into the left arm 120 (from the left wall) and into the right arm (from the right wall). Fractions of fluid containing a low concentration of high-density particles can then be collected at the left outlet 170 and the right outlet 180. The fraction of fluid containing a high concentration of high-density particles can be collected at the top outlet 190. In FIG. 13 is shown how a number of high density particles (higher density than surrounding fluid) accumulates in a central division and can be collected at a central outlet 91, whereas fluid with a low or zero concentration of said particles flows out at the lateral divisions and outlets 92. As a comparison, FIG. 14 shows one way of using a two-node standing wave pattern c.f. FIG. 11b, to move the particles so that they can be collected at two lateral divisions provided with outlets 102. Fluid with a low or zero concentration of said particles flows out at the central division and outlet 101. A similar effect could also be achieved using five divisions or channels, where the most lateral channels and the central channel collect fluid with low or zero concentration of high density particles, and the other two channels collect fluid with high concentration of said particles, i.e. n=3 below.

By controlling the frequency of the ultrasound that creates the standing wave field it is possible to generate a standing wave between the vertical walls of the base stem 110 with a standing wave length of 0.5, 1.5, 2.5 etc. wavelengths, i.e., n times 0.5 wavelengths, n=1, 3, 5, 7 . . . . cf. FIG. 11. A device having the ability to separate particles into the nodes and antinodes could therefore have a number of branching channels after the branching point corresponding to the number of nodes plus the number of antinodes in the standing wave field. For example, frequencies having 0.5, 1,5 and 2.5 wavelengths across the base stem 110 could have 3, 5 and 7 branches correspondingly.

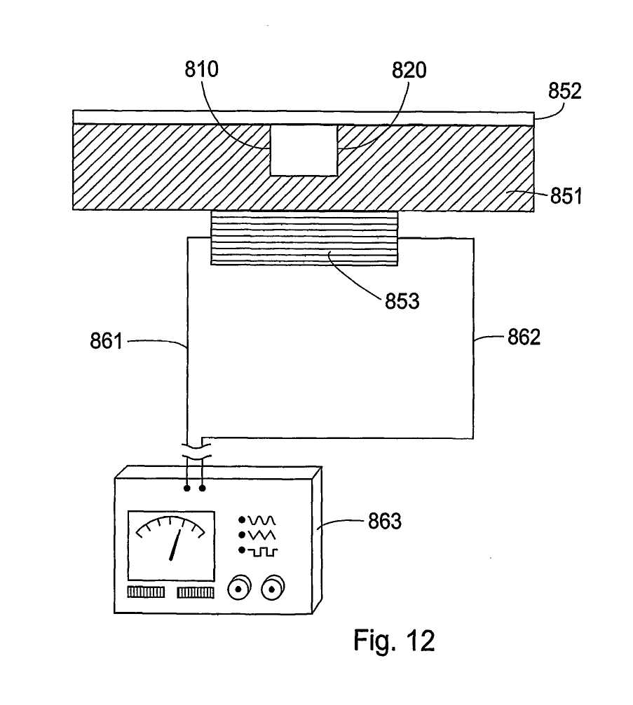

Preferred embodiments of the separation system therefore include means for controlling the frequency of the ultrasound generating means. In FIG. 12 is shown how a control unit 863 (shown in a different scale) can be connected to the piezoelectric element 853. Said control unit 863 is capable of delivering electrical energy to said element 853. Said electrical energy is controllable with regard to waveform, frequency and power, where said waveform is controllable to be one of, but not limited to sinus wave, triangular wave or square wave.

Other embodiments of the separation system include bifurcations and “trifurcations” of different shape, integrated on the same piece of material, and with the overall purpose to divide the laminar flow of fluid.

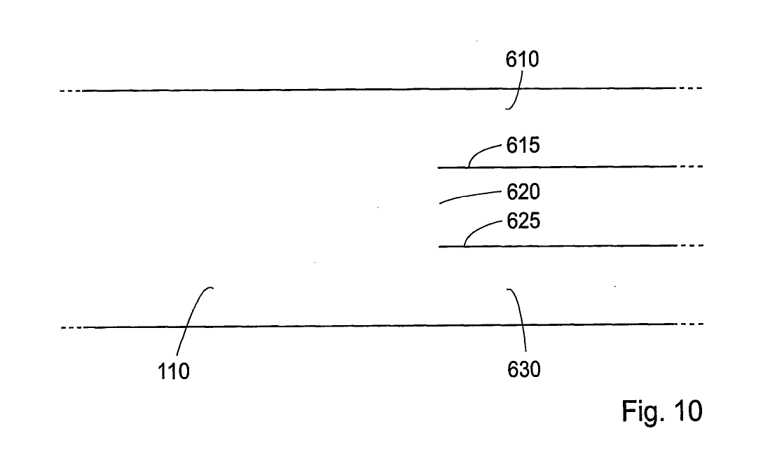

In FIG. 10 is shown a detail of another embodiment where the branching point comprises the branching of the base stem 110 directly into three parallel arms 610, 620, 630 divided by thin dividing walls. By the use of the techniques described below it is possible to form and arrange these thin walls with a thickness of down to 1 micrometer and even lower. Preferred interval includes thickness of 1-20 micrometer. Thin walls will give better performance due to better preservation of the laminar flow profile across the full channel width.

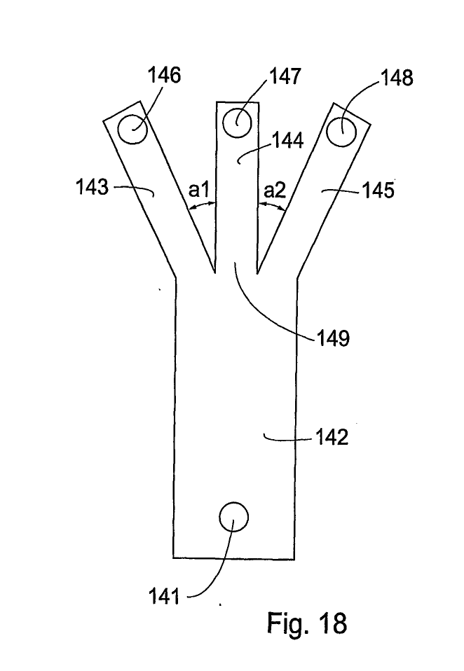

FIG. 18 shows an embodiment with a left branching angle al between a left arm 143 and a central arm 144 and a right branching angle a2 between said central arm 144 and a right arm 145. By varying the angles al and a2 it is possible to optimize certain factors such as e.g. the degree of particle concentration. However, certain angles can be difficult to manufacture with certain manufacturing processes. Angles between 0 and 90 degrees show good ability to separate flow.

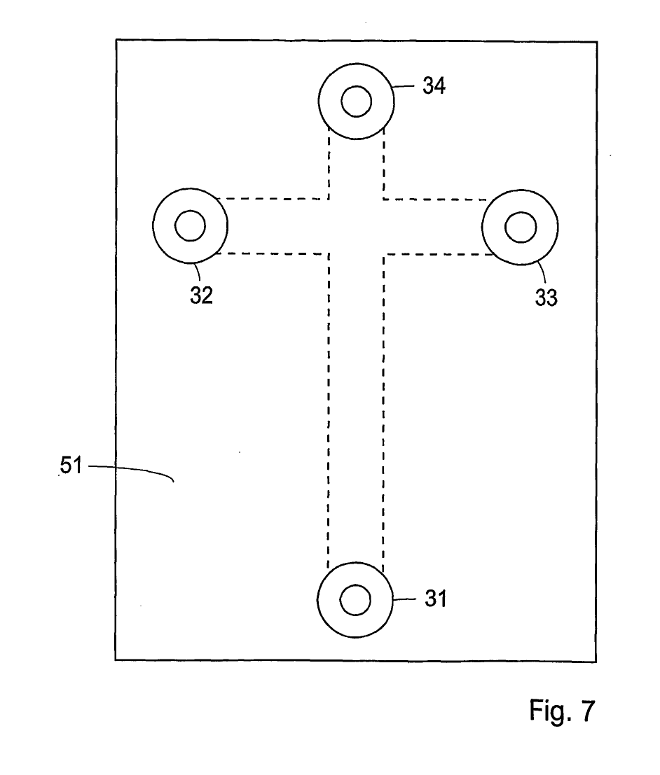

In FIG. 7, which shows the device from beneath, are shown the connections 31-34 to the inlet 160 and to the outlets 170, 180, 190 from FIG. 5. The piezoelectric element is omitted for the sake of clarity.

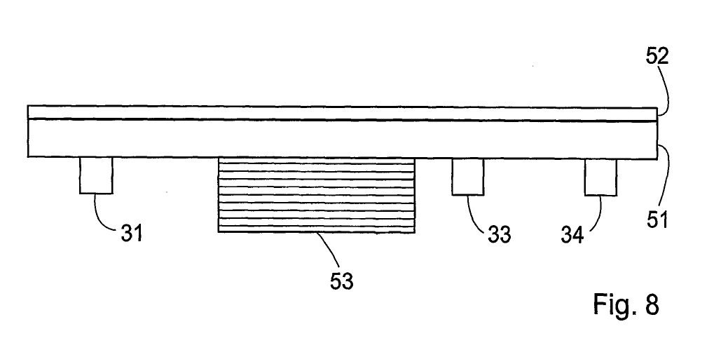

In FIG. 8 the device is shown from the side. The device preferably comprises two plates, one base plate 51 including the channel system, made e.g. of silicon, and one sealing plate or lamina 52 made of e.g. glass which makes it possible to visually inspect the process. The sealing glass plate could preferably be bonded with known techniques to the base plate 51. The piezoelectric element 53 is arranged in acoustic contact with the base plate 51.

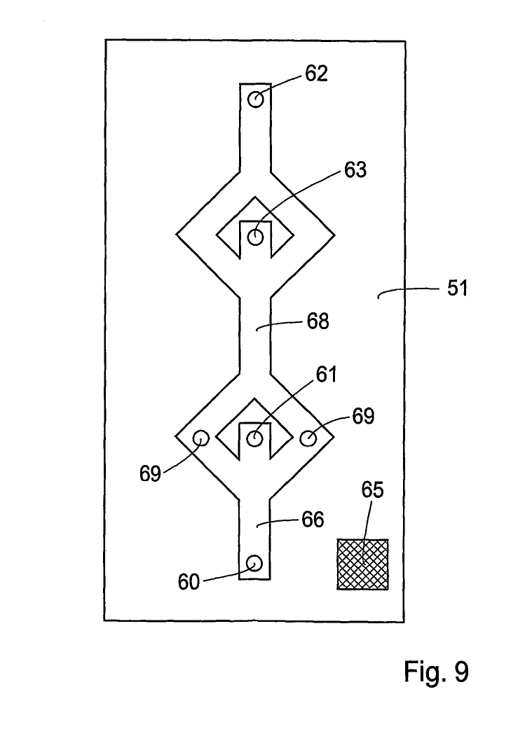

In FIGS. 9, 15, 16, and 17 arrangements are shown where certain effects can be achieved through a consecutive use of repeated structures. For example, high and low density particles can be separated using the arrangement in FIG. 9. (High and low density indicate merely the density relatively to the surrounding fluid). Here, fluid is entered at a main inlet 60. With a one-node resonance condition is present, fluid with high concentration of high-density particles will accumulate at outlet 61. Fluid with low concentration of high-density particles together with high concentration of low-density particles will accumulate at outlet 62, and fluid with intermediate concentration of high-density particles will accumulated at outlet 63. A piezoelectric element 65 is arranged in acoustic contact with the plate 51, giving rise to standing wave fields in channels with appropriate dimensions, i.e. the channel parts 66 and 68. To compensate for fluid loss, inlets 69 are provided for adding pure fluid without particles. The inlets 69 could also be used for cleaning of the system.

Parallel arrangements of single or serial structures according to FIGS. 9, 15, 16, and 17 can easily be achieved. Channel systems could e.g. repeatedly and interconnectedly be arranged, filling the area of a silicon wafer or other large area sheets of other materials such as e.g. plastics. Parallel arrangements will add capacity, i.e. more fluid volume can be processed per time interval.

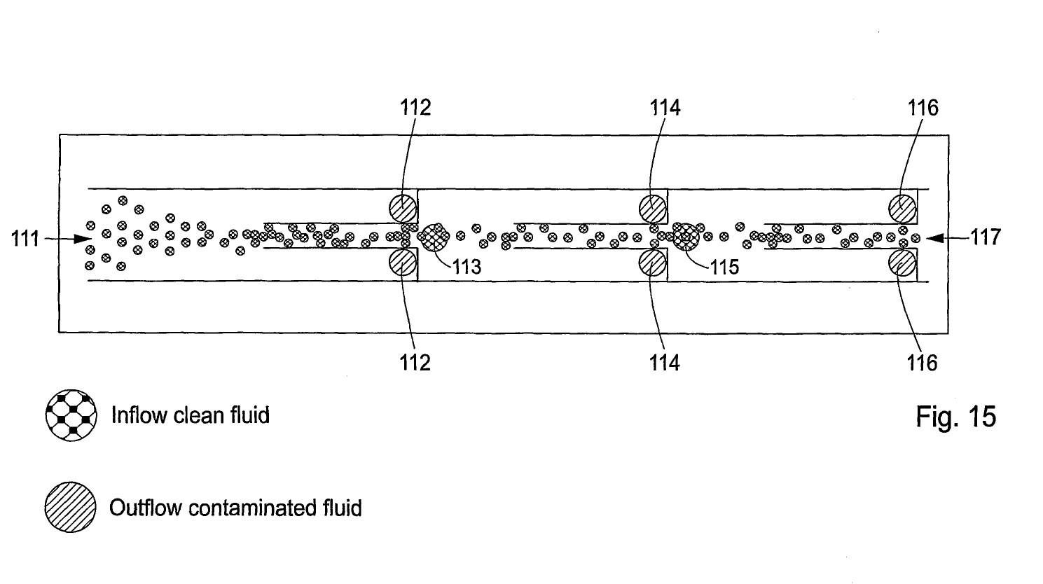

FIG. 15 shows schematically a one-node three-step fluid exchange. Contaminated fluid with particles of interest to save (e.g. red blood cells) enters at inlet 111. Contaminated fluid with low or zero concentration of particles leaves at outlets 112. Particles continue to flow, passing inlet 113 which adds clean fluid to the particles and some still remaining contaminants will become more diluted. Separation will be repeated in a second step where contaminated fluid with low or zero concentration of particles leaves at outlets 114. Particles continue to flow, passing inlet 115, which adds clean fluid to the particles and if still some remaining contaminants, these will become even more diluted. Separation will then be repeated in a third step, and particles suspended in now very clean fluid will leave at outlet 117.

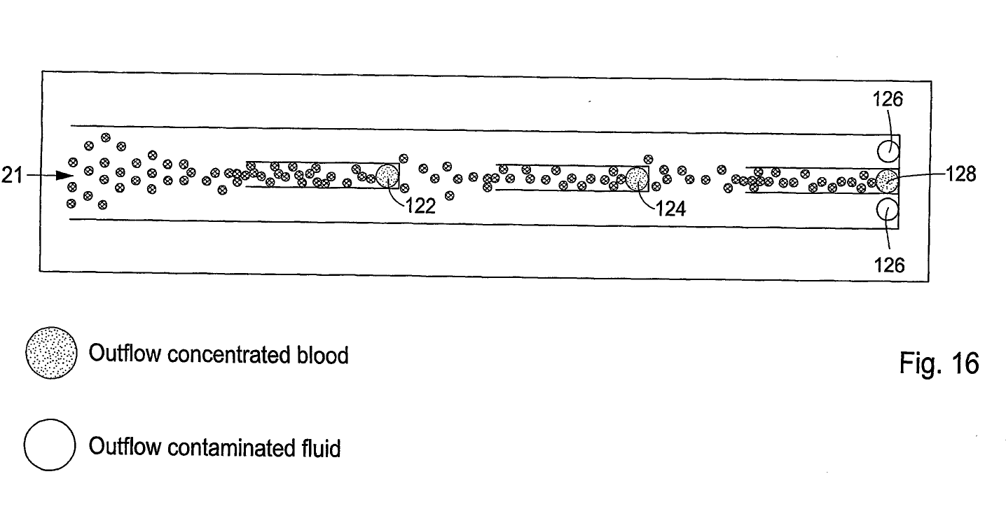

FIG. 16 shows schematically a one-node three-step serial concentrator. Contaminated fluid with particles of interest to save (e.g. red blood cells) enters at inlet 121. Particles are concentrated at outlets 122, 124 and 128. Contaminated fluid is removed at outlets 126.

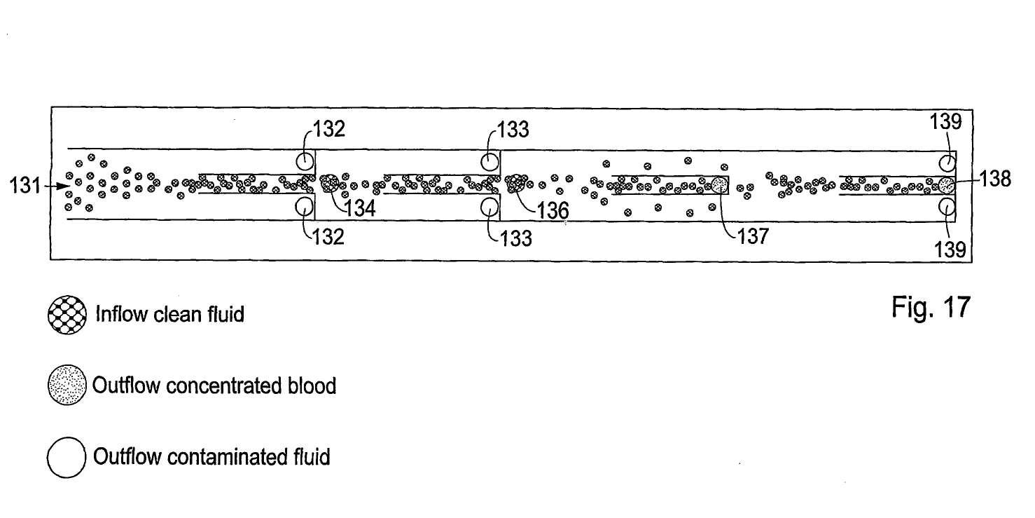

FIG. 17 shows schematically a one-node four-step integrated fluid exchanger and concentrator. Contaminated fluid with particles of interest to save (e.g. red blood cells) enters at inlet 131. Contaminated fluid with low or zero concentration of said particles leaves at outlets 132. Clean fluid is added at inlet 134. In a second step, (less) contaminated fluid with low or zero concentration of particles leaves at outlets 133. Clean fluid is added at inlet 136. In steps 3 and 4 particles are concentrated and removed through outlets 137 and 138. Excess fluid is removed through outlets 139.

Returning now to FIG. 5, the channel system, including the base stem 110 and the branching point, is preferably integrated on a plate 51 comprising a single piece of homogenous material 51 in FIG. 8. This entails the advantage of ease to repeat a number of channel systems thereby easily increasing the capacity of the separation apparatus.

Preferred embodiments include embodiments with channel systems integrated with a single substrate or deposited on a substrate by a continuous series of compatible processes.

The device can be manufactured for example in silicon. The requirement to make the walls of the base stem (810, 820) vertical or near vertical and parallel or near parallel to each other is easily fulfilled by using silicon of a <110> crystal structure and well known etching techniques. The desired vertical channel wall structure may also be realized by deep reactive ion etching, DRIE.

It is also possible to form the layers in plastic materials, for instance by using a silicon matrix. Many plastics have good chemical properties. The silicon layer structure can be produced by means of well-known technologies. Channels and cavities can be produced by means of anisotropic etching or plasma etching techniques. The silicon layer may be protected against etching by an oxide layer, that is by forming a SiO₂ layer. Patterns may be arranged in the SiO₂ layer by means of lithographic technologies. Also, etching may be selectively stopped by doping the silicon and using pn etch stop or other etch stop techniques. Since all these process steps are well known in the art they are not described in detail here.

The above described technology is also suitable for producing a matrix or mould for moulding or casting devices in e.g. plastic.

The piezoelectric element providing the mechanical oscillations is preferably of the so-called multi-layer type, but a bimorph piezoceramic element may also be used as well as any other kind of ultrasound generating element with suitable dimensions.

Depending on the application of the separation system, the shape and dimensions of the channel, the length of the stem 110 and the arms 120, 130, 140, and the frequency of the ultrasound may vary. For example, in an application for separating out red blood cells from diluted blood, the channel is preferably rectangular in cross-section and the stem part of the channel has a width of 700 micrometer for a one-node standing wave ultrasound field. Greater widths will be appropriate for standing wave ultrasound fields with more nodes.

The tolerance of the width of the channel is important. The difference should preferably be less than a few percent of half the wavelength of the frequency used in the material/the fluid concerned.

Dialysis Treatment

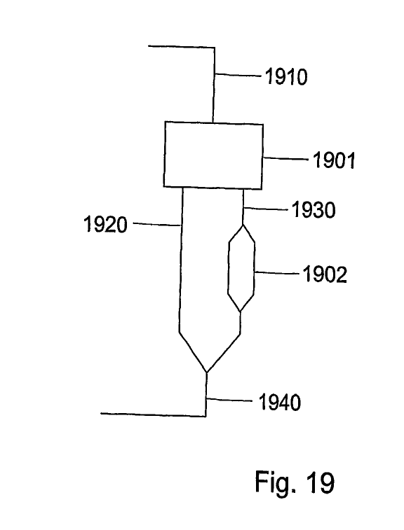

A first embodiment of the system for treatment of whole blood according to the present invention comprises dialysis treatment of the blood plasma, which embodiment is shown in FIG. 19. Blood from a patient is supplied to a separation unit 1901, via a first conduit for fluid 1910. In the separation unit 1901 the blood is separated into a first and a second component. Blood cells i.e. red blood cells, white blood cells and trombocytes are separated from the blood plasma forming the first component, which component is transported from the separation unit 1901, via a second fluid conduit 1920 and the second component rich in blood plasma devoid of cells, is transported via a third fluid conduit 1930. In an embodiment of the invention, which is devised for dialysis treatment, the blood plasma in the third conduit 1930 is transported through a dialysis apparatus 1902, for example a dialysis filter, or another device by means of which breakdown products or other substances in the blood plasma may be removed. After removing the breakdown products the in this way cleaned plasma is again brought together with the blood cell rich component, in a fourth fluid conduit 1940, wherein the purified blood may be brought back to the patient.

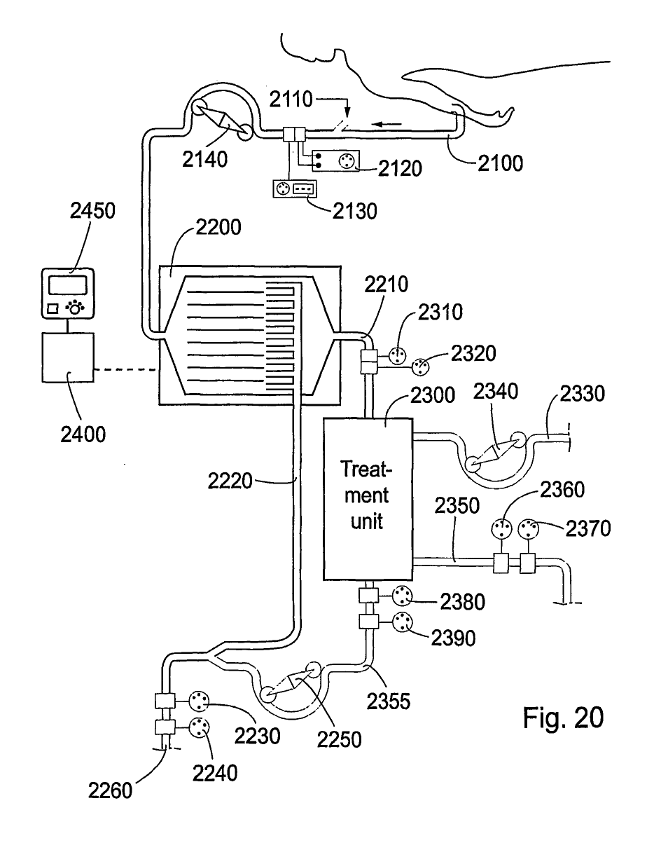

In FIG. 20, is in more detail another embodiment of the system for the treatment of whole blood according to the invention comprising dialysis shown. The embodiment of the system comprises an inflow 2100 of blood from a patient and an inflow 2110 of fluid, such as heparine, ringer-acetate, a sodium chloride solution or a buffer. Further, the embodiment of the system comprises a flow- and pressure sensor 2120, a detector 2130 arranged to measure the concentration of red blood cells, a roller pump 2140, or another device controlling the flow speed, e.g. another pump or a valve, controlling the flow of blood from the patient to the separation unit 2200. In the separation unit 2200 the separation of the blood into a cell rich and a plasma rich component according to the above-described first separation step using an acoustic filter. The embodiment of the system for dialysis treatment comprises further an outflow from the separation unit 2200. This outflow is provided by means of a conduit 2220 transporting the cell rich component past the process. Further, the embodiment of the system comprises a second flow- and pressure sensor 2230 arranged at the conduit 2220. At the conduit 2220 is further a detector 2240 arranged, which detector 2240 is arranged to measure the concentration of red blood cells after the separation unit 2200. From the separation unit 2200 is a further outflow provided, via a conduit 2210 to a dialysis apparatus 2300, such as a dialysis filter 2300. This outflow comprises the plasma rich component. The dialysis filter 2300 is arranged to perform dialysis of the plasma rich component with dialysis fluid supplied via a conduit 2330 by means of a roller pump 2340, or another device controlling the flow speed, e.g. another pump or a valve. Further, a flow- and pressure sensor 2310 and a detector 2320 are arranged at the conduit 2210. The detector 2320 is arranged to measure the concentration of red blood cells. The outflow of dialysis fluid after the dialysis filter 2300 is provided by means of a conduit 2350 at which conduit 2350 a flow- and pressure sensor 2360 and a detector 2370 are arranged. Said detector 2370 is arranged to measure the concentration of red blood cells. Via a conduit 2355 the dialyzed plasma rich component is transported from the dialysis filter 2300 to a conduit 2260 by means of a roller pump 2250, or another device controlling the flow speed, e.g. another pump or a valve. At the conduit 2355 a flow- and pressure sensor 2380 and a detector 2390 are arranged, wherein the detector 2390 is arranged to measure the concentration of red blood cells. Said conduit 2260 will thus comprise a mixture of the cell rich component and the dialyzed plasma rich component, which mixture by means of the roller pump 2250 may be brought back to the patient.

Further, the embodiment of the system comprises a control unit 2400, comprising a wave generator and an amplifier to the ultrasound separation in the separation unit 2200, drive electronics to the roller pumps 2140, 2340, 2250, measuring electronic to the sensors and the detectors, 2120, 2130, 2310, 2320, 2360, 2370, 2380, 2390, 2230, 2240, and electronics and software, which control the process dependent on the sensors and parameters from a user interface 2450. By means of the user interface a user may retrieve information about the process rate, the amount processed, pressures and flows, fault and warning messages. The user may specify variables of the process, such as process rate.

Plasma Donation

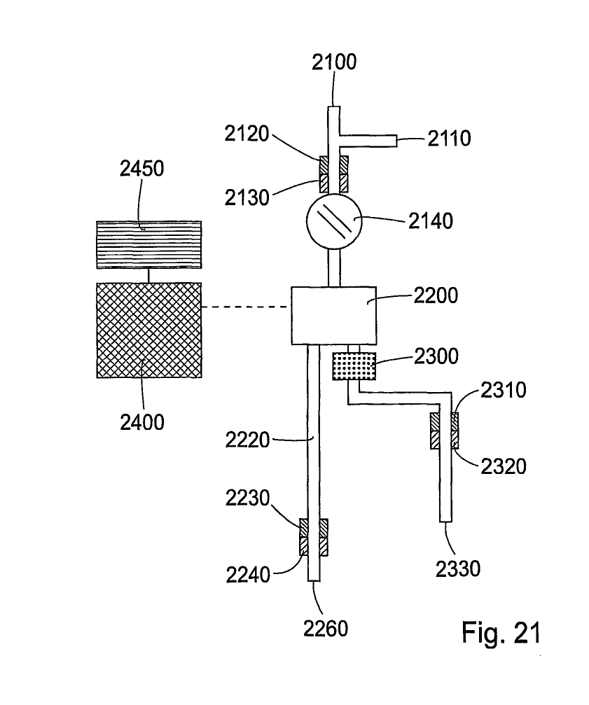

A second embodiment of the system for treatment of whole blood according to the present invention comprises plasma collection in conjunction with plasma donations or whole blood donation, which embodiment is shown in FIG. 21. The embodiment of the system comprises an inflow 2100 of blood from a patient and an inflow 2110 of fluid, such as heparine, ringer-acetate, a sodium chloride solution or a buffer. At said conduit 2100, 2110 a flow- and pressure sensor 2120, and a detector 2130 arranged to measure the concentration of red blood cells. Further, a roller pump 2140, or another device controlling the flow speed, e.g. another pump or a valve, is comprised in one embodiment of the system, wherein the roller pump 2140 is pumping blood from the patient to the separation unit 2200. In the separation unit 2200 the separation of the blood into a cell rich and a plasma rich component according to the above-described blood separation using an acoustic filter. The embodiment of the system for plasma donation comprises further an outflow from the separation unit 2200. This outflow is provided by means of a conduit 2220 transporting the cell rich component past the process. Further, one embodiment of the system comprises a second flow- and pressure sensor 2230 arranged at the conduit 2220. At the conduit 2220 is further a detector 2240 arranged, which detector 2240 is arranged to measure the concentration of red blood cells after the separation unit 2200. At the conduit 2220 is further a conduit 2260 connected, which conduit 2260 is connectable to a patient by means of a vein catheter. The outflow of the plasma rich component, for example for use as a donor plasma or as a raw product in the production of pharmaceuticals, from the separation unit 2220 by means of a conduit 2330. At this conduit is a treatment unit 2300, in the shape of a membrane 2300, arranged, which membrane 2300 is arranged to separate particles or proteins from the plasma rich component. In one embodiment of the invention, the membrane 2300 is arranged to separate between particles having a diameter larger than 1 micron and particles having a diameter less than 1 micron. However, it should be understood that another type of membrane could be arranged to separate between particles having other diameters and to separate proteins. The membrane 2300 may also be integrated with the separation unit 2200. Further at the conduit 2330, a flow- and pressure sensor 2310 and a detector 2320 are arranged, wherein the detector 2320 is arranged to measure the concentration of red blood cells.

Further, one embodiment of the system comprises a control unit 2400, comprising a wave generator and an amplifier to the ultrasound separation in the separation unit 2200, drive electronics to the roller pump 2140, measuring electronic to the sensors and the detectors, 2120, 2130, 2310, 2320, 2230, 2240, and electronics and software, which control the process dependent on the sensors and parameters from a user interface 2450. By means of the user interface a user may retrieve information about the process rate, the amount processed, pressures and flows, fault and warning messages. The user may specify variables of the process, such as process rate and the grade of separation.

Plasmapheresis

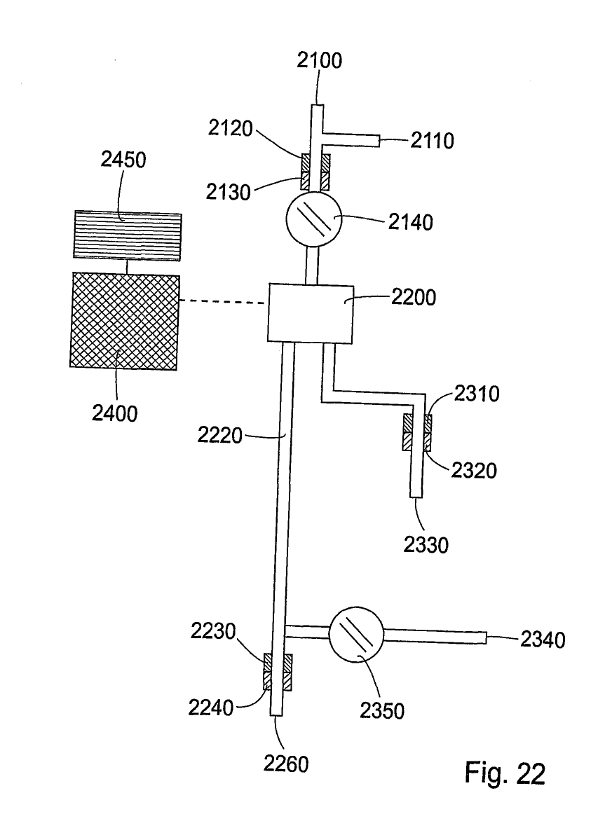

A third embodiment of the system for treatment of whole blood according to the present invention comprises plasmapheresis, which embodiment is shown in FIG. 22. The embodiment of the system comprises an inflow 2100 of blood from a patient and an inflow 2110 of fluid, such as heparine, ringer-acetate, a sodium chloride solution or a buffer. At said conduit 2100 a flow- and pressure sensor 2120, and a detector 2130 are arranged, which detector 2130 is arranged to measure the concentration of red blood cells. Further, a roller pump 2140, or another device controlling the flow speed, e.g. another pump or a valve, is comprised in the embodiment, wherein the roller pump 2140 is pumping blood from the patient to the separation unit 2200. In the separation unit 2200 the separation of the blood into a cell rich and a plasma rich component according to the above-described blood separation using an acoustic filter. The embodiment of the system for plasma-pheresis comprises further an outflow from the separation unit 2200. This outflow is provided by means of a conduit 2220 transporting the cell rich component. Further, the embodiment of the system comprises a second flow- and pressure sensor 2230 arranged at the conduit 2220. At the conduit 2220 is further a detector 2240 arranged, which detector 2240 is arranged to measure the concentration of red blood cells after the separation unit 2200. By means of a conduit 2340 the inflow of substitution fluid, such as fresh frozen or stored plasma from a blood central, natrium chloride solution ringer-acetat solution, albumin, or other plasma expanders, is performed to the conduit 2220 by means of a roller pump 2350. The substitution solution is mixed with the cell rich component in the conduit 2260, wherein the mixture may be brought back to the patient. From the separation unit 2200 an outflow 2330 of the plasma rich component to a treatment unit (not shown) is arranged. In the treatment unit the plasma rich component is destroyed, discarded or is exposed to a process with for example monoclonal antibodies to remove toxines, proteins, or other techniques for treating blood plasma. At the conduit 2330 is a flow- and pressure sensor 2310 and a detector 2320 arranged, wherein the detector is arranged to measure the concentration of red blood cells.

Further, the embodiment of the system comprises a control unit 2400, comprising a wave generator and an amplifier to the ultrasound separation in the separation unit 2200. The system comprises further drive electronics to the roller pumps 2140, 2350, measuring electronic to the sensors and the detectors, 2120, 2130, 2310, 2320, 2230, 2240, and electronics and software, which control the process dependent on the sensors and parameters from a user interface 2450. By means of the user interface a user may retrieve information about the process rate, the amount processed, pressures and flows, fault and warning messages. The user may specify variables of the process, such as process rate and the grade of separation.

The invention also comprises a blood product, i.e. a blood plasma rich product and/or a blood cell rich product, resulting from a process in accordance with the steps of the inventive method.

Returning to FIG. 1c a separation unit comprising eight channel units 1501-1508, which units are supplied with fluid from a distribution cavity 1510 having one inlet 1512 and eight outlets 1521-1528. Each channel unit 1501-1508 is provided with three outlets, one central outlet 1541 and two lateral outlets. Said lateral outlets are connected in pairs, except for the two most lateral outlets of the separation unit 1500, forming nine intermediate outlets 1531-1539. Said intermediate outlet are connected to a fast collecting cavity (not shown) alternatively to a first collecting manifold (not shown). The central outlets 1541-1548 are connected to a second collecting cavity alternatively to a second collecting manifold (neither shown).

FIGS. 1a and 1b shows the separation unit 1500 of FIG. 1c in a perspective view. The plate 1602 in which the separation unit 1500 is formed is arranged on top of an ultrasound source 1620, preferably a piezoelectric element 1620 and a support structure 1612. An inlet tube 1610 is connected to the distribution cavity inlet 1542 to provide an inlet for the fluid connectable to outside tubing.

A first outlet tube 1631 is providing a connection from the nine intermediate outlets 1531-1539 via a first collecting manifold to a free end 1641 of said first outlet tube 1631. A second outlet tube 1632 is providing a connection from the eight central outlets 1541-1548 via a second collecting manifold to a free end 1642 of said second outlet tube 1632.

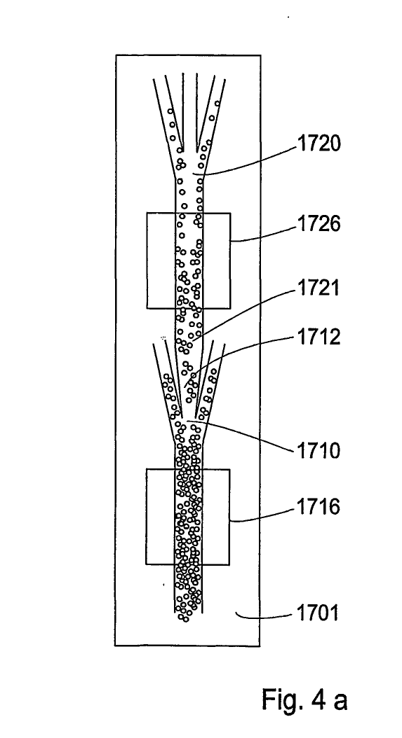

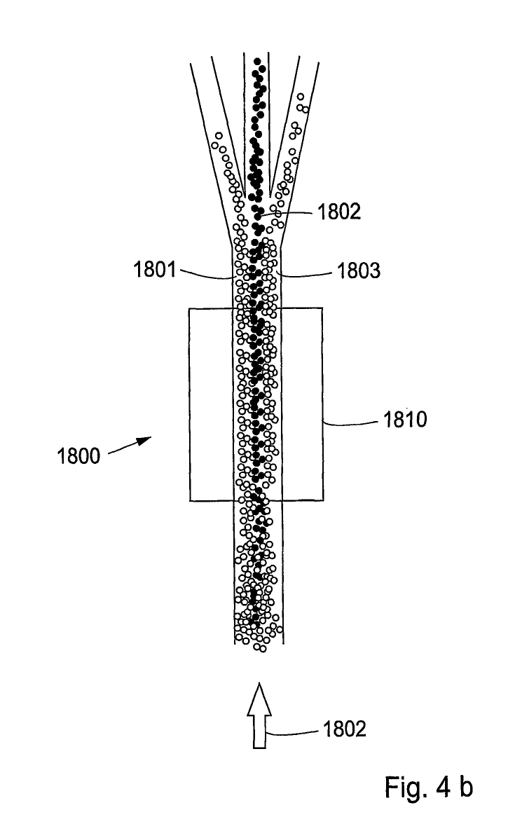

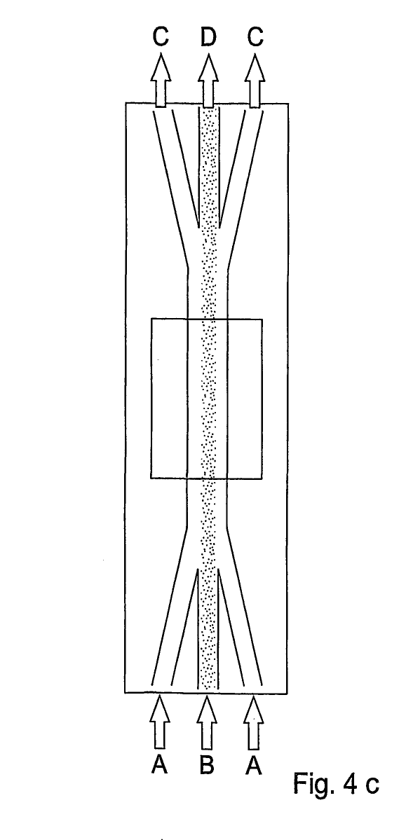

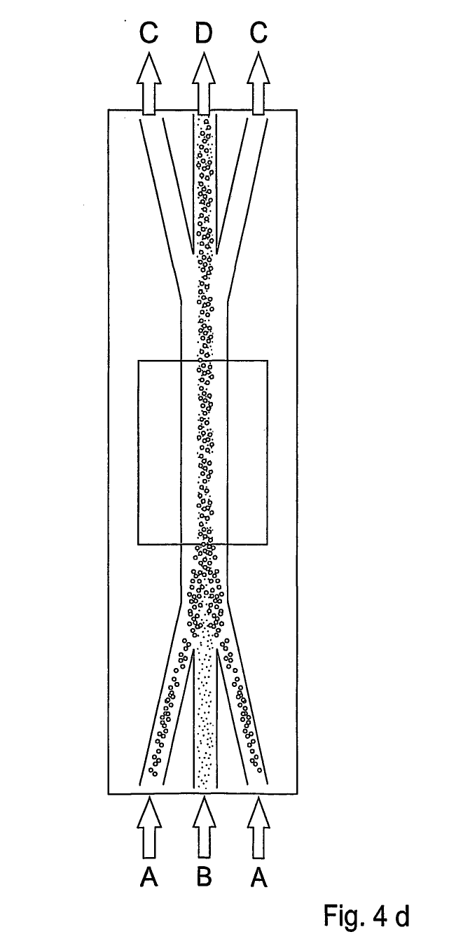

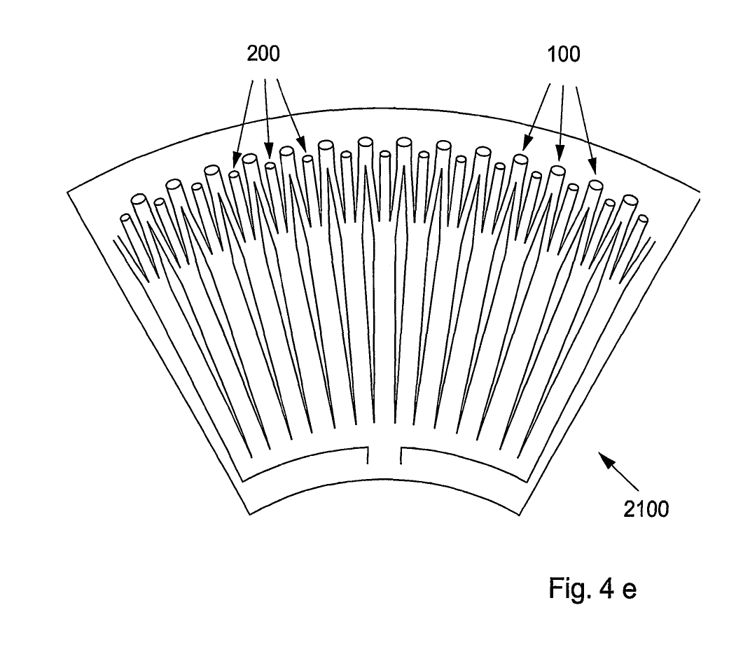

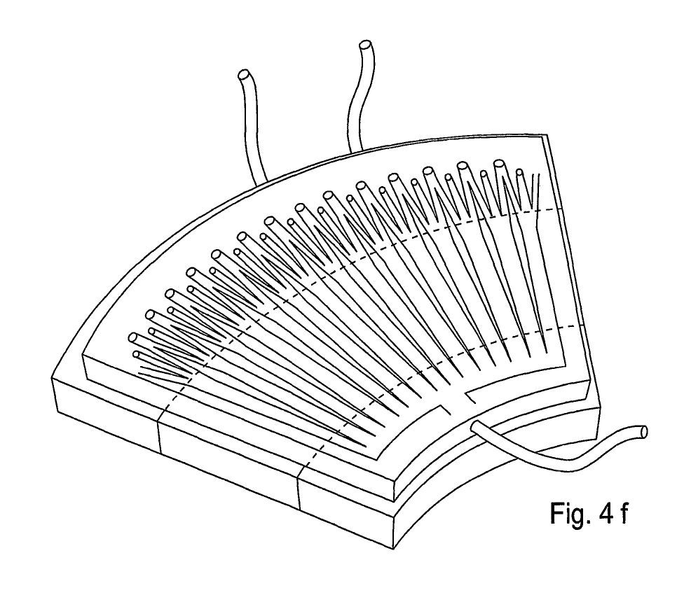

FIG. 4a shows a serial arrangement in a plate 1701 of two channel units, devised to increase particle separation from a fluid. A first channel unit 1710 is formed in the plate 1701 having a central branch 1712, which branch is connected to a base channel 1721 of a second channel unit 1720. Each channel unit 1710, 1720 is provided with ultrasound energy from piezoelectric elements arranged under the plate 1701 at positions approximately under a central portion of the base channel of each channel unit as indicated by rectangles 1716, 1726.

FIG. 4b shows a channel unit 1800 used to separate a fluid containing two types of particles, indicated as black and white, respectively.

When fluid flows in the direction of the arrow 1802, ultrasound-standing waves are separating the particles in the channel unit into three fluid layers 1801-1803. The position of the ultrasound source is indicated by the rectangle 1810.

The described process separating two types of particles is illustrating a solution to the need within the field of medical technology to separate blood components from each other, i.e. red and white blood cells and platelets (erythrocytes, leukocytes and thrombocytes), also called the formed elements of the blood.

Irnown art in the field comprises mainly or solely solutions based on centrifugation. A disadvantage is that it is very difficult to obtain a complete separation of the formed elements, instead a so-called “buffy coat” is obtained. This buffy coat comprises a high concentration of thrombocytes, leukocytes and a low concentration of erythrocytes. In this context one should bear in mind that the sensitive thrombocytes have been centrifugated and subjected to high g-forces, which probably have induced an impaired function within said erythrocytes.

An embodiment of the present invention can be used to separate thrombocytes and leukocytes from erythrocytes, because they possess different densities as can be seen in table 1. Blood consists of plasma and formed elements.

TABLE 1

| | Relative density | Standard deviation |
|---|---|---|
| Particles | | |
| Erythrocytes | 1.09645 | 0.0018 |
| Leukocytes | 1.07-1.08 | N/A |
| Thrombocytes | 1.0645 | 0.0015 |
| Fluids | | |
| Plasma | 1.0269 | 0.0009 |
| Glucose 30% | 1.10 | 0 |
| Glucose 50% | 1.17 | 0 |
| Addex electrolyte | 1.18 | 0 |

Relative density. Source: Geigy Scientific Tables

As can be seen in table 1, different components have different density. The variation in density is very small for the table entries. When ordinary blood is separated, a channel unit will separate all formed elements in the same way, because their density is higher than the medium they are suspended in, i.e. the plasma.

As an alternative embodiment, the medium is modified, i.e. the plasma is modified so that its density is altered, giving the possibility to separate the different blood cells. This is achieved by adding an amount of denser liquid to the plasma and thereby dilute the plasma to a lower concentration, but with a higher density. Fluids from table 1 can be used, together with other possible solutions such as iodine contrast agents, which possess high density.

### EXAMPLES

Take 100 ml blood with a haematocrit of 40%. This entails that 60% (=60 ml) of the blood is plasma. The plasma has a density of 1.0269. By adding 30 ml of 50% glucose solution we get according to the formula:

$${d}_{tot} = \frac{{v}_{1} * {d}_{1} + {v}_{2} * {d}_{2}}{{v}_{1} + {v}_{2}}$$

where

v₁ is the volume of the first fluid

d₁ is the density of the first fluid

v₂ is the volume of the second fluid

d₂ is the density of the second fluid

dₜₒₜ is the density of the mix

The density of the mix medium becomes 1.0746.

When this mixture is entered in an embodiment, a separation is achieved where thrombocytes and erythrocytes are directed into separate branches, because now the thrombocytes are lighter than the medium.

This is of course just an example. It is also possible to separate out leukocytes because they have a specific weight, different from the one of erythrocytes and thrombocytes. It should also be possible to separate out bacteria and virus with this method. The method can be used on all solutions except those solutions where it is impossible or otherwise inappropriate to manipulate the density of the solution.

FIG. 4c and FIG. 4d shows a channel unit with three inlets A, B, A and three outlets C, D, C. A first fluid is fed to the channel unit at both A-inlets and a second fluid is fed to the B inlet. At this microscale, the fluids will not blend.

FIG. 20 shows how particles from the fluid entered at the A-inlets are forced by the ultrasound standing wave field to migrate over to the fluid entered at the B-inlet. This type of “separation” is especially useful when the objective is to keep formed elements of the blood and discard the plasma, as in e.g. plasmapheresis and also in blood wash were blood cells in contaminated plasma (A) are moved to a clean solution (B) and finally blood cells in a clean medium is produced (D). The waste plasma (C) is discarded. This method will enable a highly efficient blood wash with very low amounts of washing substance needed.

FIGS. 4e and 4f show a radial arrangement of the channel units, said arrangement being particularly advantageous when base material of the plate are circular discs or the like.

It will be appreciated by persons skilled in the art that the structure of the device according to the present invention has several advantages including ease of manufacture and solving of the problem of separating particles liable to disintegration in filtering and centrifugation processes.

The invention has been explained by means of exemplifying embodiments, but other implementations of the invention within the scope of the accompanying claims are also conceivable.

1. A system for treatment of whole blood, comprising a separation apparatus (10,2200), a treatment apparatus (18) and fluid conduits (1, 15, 17, 19), wherein a first conduit (1) is arranged to transport blood to the separation apparatus (10,2200), characterized in that the separation apparatus (10,2200) comprises a an ultrasound microchannel separator, comprising a plate with a number of channel units formed in a layer of said plate near a first surface, and an ultrasound source arranged in close contact to a second surface, opposing the first surface, devised to separate blood cells from blood plasma, wherein the blood cell rich component is transported from the separation apparatus (10,2200) via a second conduit (12) and in that the blood plasma rich component is transported to the treatment apparatus (18) via a third conduit (19), and in that the treatment apparatus (18) is capable of treating the blood plasma rich component.

2. The system according to claim 1, characterized in that the separation apparatus (10,2200) further comprises;
a first inlet for inputting blood to the container;
possibly a second inlet for inputting possible substitution fluid to the container;
a first outlet for outputting a first blood product;
a second outlet for outputting a second blood product.

3. The system according to claim 2, characterized in that the liquid flow mechanism is arranged such that gravitation causes the liquid to flow through the standing ultrasound wave.

4. The system according to claim 3, characterized in that the microchannel separator comprises an integrated channel system, including an inlet (160), a base stem (110), a branching point (175) and two or more outlets (170, 180, 190) and oscillation means (53, 150) for delivering mechanical energy to the surroundings of, and fluid in, said channel; arranged so that the concentration of particles in laminar layers of fluid in the base stem (110) changes the fluid flows towards the branching point; and that said branching point (175) has a shape to separate said layers into separate branches.

5. The system according to any of the claims 1-4, characterized in that the blood cell rich component and the blood plasma rich component are united in a fourth conduit (5).

6. The system according to any of the claims 1-4, characterized in that the treatment apparatus (18) is a dialysis apparatus (18, 2300) arranged to remove breakdown products from the blood plasma rich component.

7. The system according to claim 6, characterized in that the dialysis apparatus (18, 2300) comprises a semi-permeable membrane.

8. The system according to claim 6, characterized in that the dialysis apparatus (2300) is a dialysis filter.

9. The system according to any of the claims 1-4, characterized in that the treatment apparatus (2) comprises a membrane (2300) for donor plasma and arranged to separate particles or proteins from blood plasma rich component.

10. The system according to any of the claims 1-4, characterized in that the treatment apparatus (2) is a treatment unit arranged to discard or destroy the blood plasma.

11. The system according any of the claims 1-4, characterized in that the treatment apparatus (2) is a treatment unit arranged to expose the blood plasma rich component to monoclonal antibodies.

12. A method for treatment of whole blood, comprising the steps of:
by means of a first conduit (10), supplying blood to a separation apparatus (1,2200);
by means of the separation apparatus (1,2200), extracorporeally preseparating blood cells from blood plasma;
by means of a second conduit (20), transporting the blood cell rich component from the separation apparatus (1,2200); and
by means of a third conduit (30) supplying the blood plasma rich component to a treatment apparatus (2).

13. The method as recited in claim 12, characterized in the step of:
separating the blood cells from the blood plasma by means of ultrasound.

14. The method as recited in claim 13, further comprising the steps of:
generating a standing ultrasonic wave in the blood such that particles of a first particle type having a first property dependent on the characteristics of the ultrasound is collected at the nodes of the standing ultrasound wave; and
establishing a flow of liquid through the standing ultrasound wave, the liquid carrying particles of a second particle type with a second property such that particles of said second particle type passes between said nodes.

15. The method as recited in claim 14, wherein said liquid is blood.

16. The method as recited in claim 14, wherein said liquid is a substitution fluid.

17. The method as recited in claim 14, further comprising the step of increasing the concentration of particles of said first particle type at the standing ultrasound wave by conducting the flow of particles of said first particle type through said ultrasound wave.

18. The method as recited in claim 14, further comprising the step of controlling the size of said first particle type dependent on the distance between the ultrasound transmitter and the reflector between which said standing ultrasound wave is generated.

19. The method as recited in claim 14, further comprising the step of controlling the size of said first particle type dependent on the ultrasound frequency at which said standing ultrasound wave is generated.

20. The method as recited in claim 14, further comprising the step of controlling the separation of particles of said first particle type from particles of a second particle type dependent on the acoustic properties of each particle type, respectively.

21. The method as recited in claim 14, further comprising the step of controlling the separation of particles of a first particle type from particles of a second particle type dependent on the density of each of the particles types, respectively.

22. The method as recited in claim 14, further comprising the steps of:
receiving blood in a container;
generating a standing ultrasound wave such that particles of a predetermined particle type is collected in the nodes of the standing wave;
possibly flowing a substitution liquid through the container;
removing the standing ultrasound wave;
emptying the container of particles of said predetermined particle type.

23. The method as recited in claim 14, using ultrasound in combination with laminar flow, and stationary wave effects further comprising the steps of
inputting fluid in a conduit forming an essentially laminar flow of a fluid containing particles;
subjecting said flow to an ultrasound stationary wave field during its flow past a distance, thereby forming a moderate essentially laminar flow with a non-uniform distribution of particles;
separating said moderated laminar flow into two or more separated flows in such a way that the concentration of particles is higher in one separated flow than in another separated flow;
collecting each separated flow for possible further processing.

24. The method according any of the claims 12-23, characterized in the step of:
bringing the blood cell rich component together with the blood plasma rich component in a fourth conduit (40).

25. The method according any of the claims 12-23, characterized in that the treatment apparatus (2) is a dialysis apparatus (2300) that removes breakdown products from the blood plasma rich component.

26. The method according any of the claims 12-23, characterized in that the treatment apparatus (2) is a membrane (2300) that separates particles or proteins from the blood plasma rich component.

27. The method according any of the claims 12-23, characterized in that the treatment apparatus (2) is a treatment unit that destroys or discards the blood plasma.

28. The method according any of the claims 12-23, characterized in that the treatment apparatus (2) is a treatment unit that exposes the blood plasma rich component to monoclonal antibodies.

29. A blood product produced through a method for treatment of whole blood comprising the steps of:
by means of a first conduit (10), supplying blood to a separation apparatus (1,2200);
by means of the separation apparatus (1,2200), extracorporeally preseparating blood cells from blood plasma;
by means of a second conduit (20), transporting the blood cell rich component from the separation apparatus (1,2200); and
by means of a third conduit (30) supplying the blood plasma rich component to a treatment apparatus (2).

30. The blood product as recited in claim 29, further comprising the step of:
separating the blood cells from the blood plasma by means of ultrasound.

31. The blood product as recited in claim 30 further produced from a first blood liquid and comprising the steps of:
generating a standing ultrasound wave through said first blood liquid such that particles of a first particle type having a first property depending of the characteristics of the ultrasound are collected at the nodes of the standing ultrasound wave;
establishing a flow of liquid through the standing ultrasound wave, the liquid carrying particles of a second particle type having a second property such that said particles of said particle type passes between said nodes.

32. The blood product as recited in claim 31, wherein said liquid is said first blood liquid.

33. The blood product as recited in claim 31, wherein said liquid is a substitution liquid.

34. The blood product as recited in claim 31, further comprising the step of increasing the concentration of particles of said first particle type at the standing ultrasound wave by flowing particles of said first particle type through said ultrasound wave.

35. The blood product as recited in claim 31, further comprising the step of controlling the size of said first particle type dependent on the distance of the ultrasound transmitter and the reflector between which said standing ultrasound wave is generated.

36. The blood product as recited in claim 31, further comprising the step of controlling the size of said first particle type dependent on the ultrasound frequency at which said standing ultrasound wave is generated.

37. The blood product as recited in claim 31, further comprising the step of controlling the separation of particles of said first particle type from particles of a second particle type dependent on the acoustic properties of each particle type, respectively.

38. The blood product as recited in claim 31, further comprising the step of controlling the separation of particles of said first particle type from particles of a second particle type dependent on the density of each of the particle types, respectively.

39. The blood product as recited in claim 31, further comprising the step of:
receiving blood in a container;
generating a standing ultrasound wave such as particles of a predetermined particle type are gathered in the nodes of the standing wave;
possibly flowing a substitution fluid through the container;
removing the standing ultrasound wave;
emptying the container of particles of said predetermined particle type.

40. The blood product as recited in claim 31, using ultrasound in combination with laminar flow and stationary wave effects, further comprising the steps of:
inputting fluid in a conduit forming an essentially laminar flow of a fluid containing particles;
subjecting said flow to an ultrasound stationary wave field during its flow past a distance, thereby forming a moderated essentially laminar flow with a non-uniform distribution of particles;
separating said moderated laminar flow to two or more separated flows in such a way that the concentration of particles is higher in one separated flow than in a another separated flow;
collecting each separated flow for possible further processing.

41. The blood product according any of the claims 31-40, produced by bringing the blood cell rich component together with the blood plasma rich component in a fourth conduit (40).

42. The blood product according any of the claims 31-40, produced by removing breakdown products from the blood plasma rich component by means of the treatment apparatus (2).

43. The blood product according any of the claims 31-40, produced by separating particles or proteins from the blood plasma rich component by means of the treatment apparatus (2).

44. The blood product according any of the claims 31-40, produced by destroying the blood plasma by means of the treatment apparatus (2).

45. The blood product according any of the claims 31-40, produced by exposing the blood plasma rich component to monoclonal antibodies by means of the treatment apparatus (2).
